(19) United States
(12) Patent Application Publication
(10) Pub. No.: US 2015/0116828 A1
(43) Pub. Date: Apr. 30, 2015

(54) ANTI-SHOCK LENS DRIVING APPARATUS

(71) Applicant: TopRay Technologies, Inc., Hsinchu (TW)

(72) Inventor: Yi-Jung CHEN, Hsinchu (TW)

(73) Assignee: TopRay Technologies, Inc., Hsinchu (TW)

(21) Appl. No.: 14/062,525

(22) Filed: Oct. 24, 2013

(51) Int. Cl. G02B 27/64

(52) U.S. Cl. CPC G02B 27/646
USPC 359/557

(57) ABSTRACT

An anti-shake lens driving apparatus is provided, including a lens carrier, for carrying at least a lens set; a magnet module, disposed on the outer surroundings of the lens carrier for pushing the lens carrier; a suspension part, further including an upper suspension resilient element and a lower suspension resilient element, the upper and lower suspension resilient elements respectively including a fixed part, a movable part and at least a suspension element; the at least a suspension element connecting the fixed part and the movable part; the fixed part being fixed to an upper cover and a base; the movable part being fixed to the upper and lower part of the lens carrier respectively; and the upper cover and the base being disposed respectively at the upper and lower part of the magnet module and the suspension part for providing protection.

### FIELD OF THE INVENTION

The present invention generally relates to a lens driving apparatus, and more specifically to an anti-shake lens driving apparatus able to providing buffering to lens.

### BACKGROUND OF THE INVENTION

Smart phone provides much convenience for communication. As the technology develops rapidly, smart phone only provides voice communication but also functions of camera and recorder, often used for shoot-and-share on various social networks. High-definition and rapid focusing mode are essential functions of smart phone; therefore, the lens module becomes a decisive factor when considering the purchase of a smart phone. The lens module is a delicate element. It is a challenge to allow the lens to operate rapidly and precisely in a limited space as well as to provide sufficient protection the lens module.

A lens module includes many fine components, wherein the lens carrier for carrying focus lens is a movable component providing focusing functions for the camera. To ensure that the lens carrier can move smoothly under any circumstance, for example, the dropping of smart phone or other impact on the smart phone. Therefore, the design of lens module must be able to absorb the external impact.

### SUMMARY OF THE INVENTION

The primary object of the present invention is to provide an anti-shake lens driving apparatus. With a monolithic design of the suspension set for carrying the lens set, the present invention can buffer the real time energy generated by the impact to protect the lens set from damage and maintain the driving apparatus to operate normally.

An embodiment of the present invention provides an anti-shake lens driving apparatus, including a lens carrier, for carrying at least a lens set; a magnet module, disposed on the outer surroundings of the lens carrier for pushing the lens carrier; a suspension part, further including an upper suspension resilient element and a lower suspension resilient element, the upper and lower suspension resilient elements respectively including a fixed part, a movable part and at least a suspension element; the at least a suspension element connecting the fixed part and the movable part; the fixed part being fixed to an upper cover and a base; the movable part being fixed to the upper and lower part of the lens carrier respectively; and the upper cover and the base being disposed respectively at the upper and lower part of the magnet module and the suspension part for providing protection.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of an embodiment of the present invention;

FIG. 2 shows a schematic view of the structure of the suspension resilient element;

FIG. 3 shows a schematic view of the assembly of the upper and lower suspension resilient elements and the lens carrier; and

FIG. 4 shows a schematic view of the magnet module.

### DETAILED DESCRIPTION OF THE PREFERRED EMBODIMENTS

The anti-shake lens driving apparatus of the present invention includes a monolithic suspension part to simplify the assembly as well as adds inner yoke within specific magnetic range to enhance movement sensitivity.

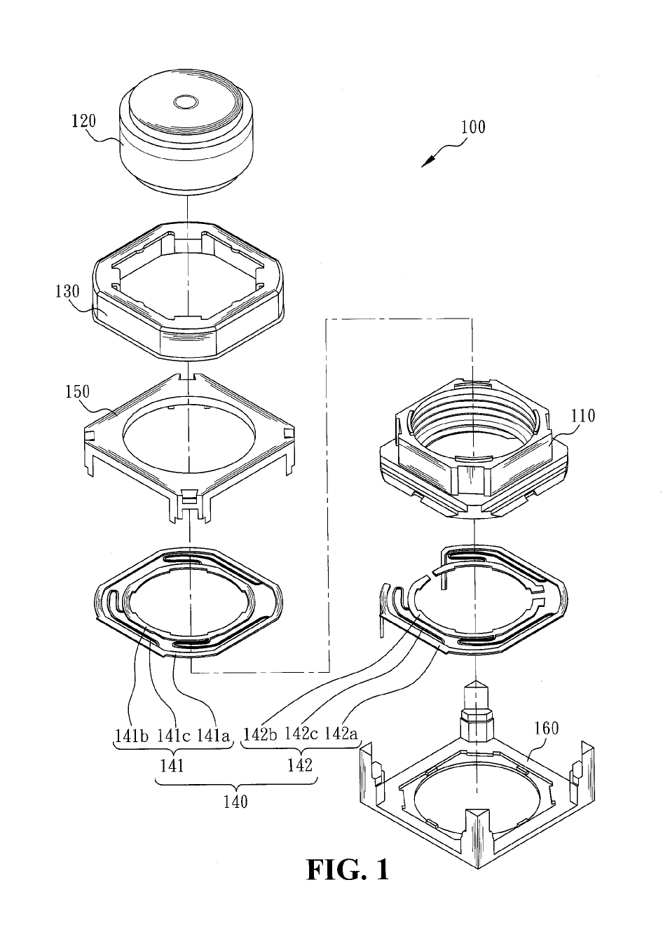

FIG. 1 shows a schematic view of an embodiment of the present invention. As shown in FIG. 1, an anti-shake lens driving apparatus 100 includes a lens carrier 110, for carrying at least a lens set 120; a magnet module 130, disposed on the outer surroundings of the lens carrier 110 for pushing the lens carrier 110; a suspension part 140, further including an upper suspension resilient element 141 and a lower suspension resilient element 142, the upper and lower suspension resilient elements respectively including a fixed part 141a, 142a, a movable part 141b, 142b and at least a suspension element 141c, 142c; the at least a suspension element 141c, 142c connecting the fixed part 141a, 142a and the movable part 141b, 142b; the fixed part 141a, 142a being fixed to an upper cover 150 and a base 160; the movable part 141b, 142b being fixed to the upper and lower part of the lens carrier 110 respectively; and the upper cover 150 and the base 160 being disposed respectively at the upper and lower part of the magnet module 130 and the suspension part 140 for providing protection.

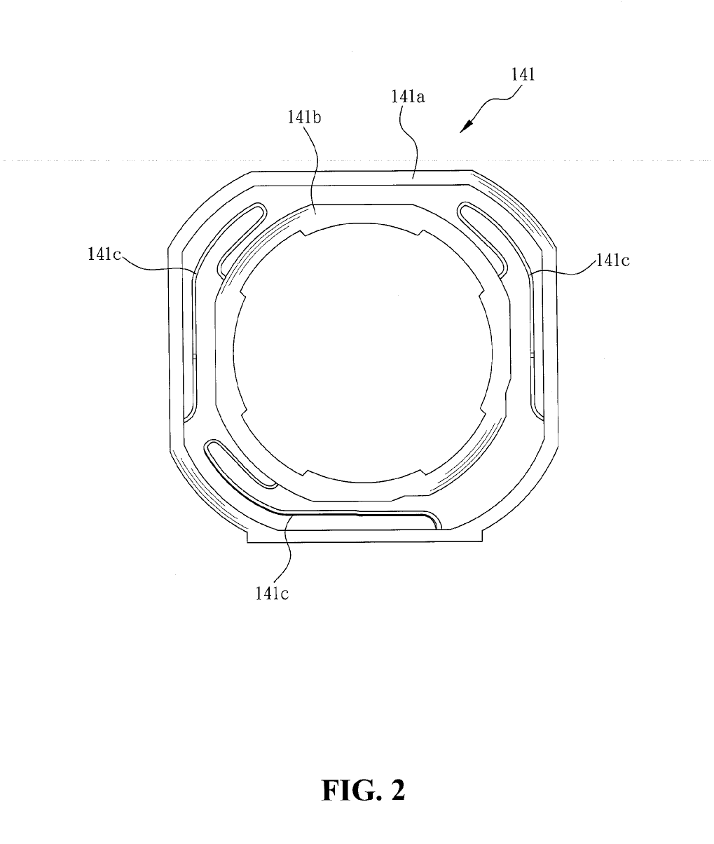

FIG. 2 shows a schematic view of the structure of the suspension resilient element. The present embodiment uses the upper suspension resilient element 141 as example for description. As shown in FIG. 2, the upper suspension resilient element 141 includes the fixed part 141a, the movable part 141b and the at least a suspension element 141c. Two ends of the suspension element 141c are connected to the fixed part 141a and movable part 141b respectively. The suspension element 141c connecting the fixed part 141a and movable part 141b extends from the fixed part 141a at an angle to reach movable part 141b, wherein the suspension element 141c is a U-shape buffer element. By adjusting the cord width of the suspension elements 141c, 142c of the upper and lower suspension resilient elements 141, 142, the rigidity of the upper and lower suspension resilient elements 141, 142 can be adjusted to achieve the compensation of the tilt angle.

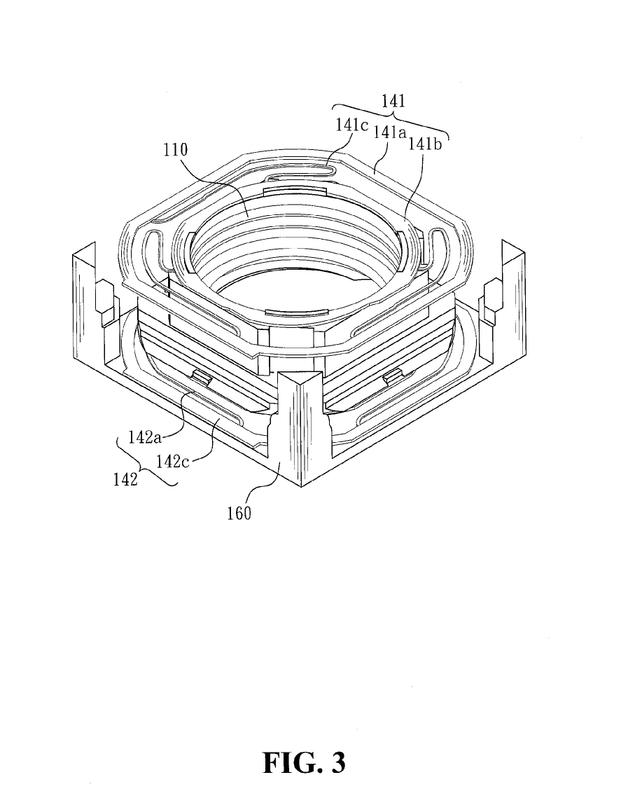

FIG. 3 shows a schematic view of the assembly of the upper and lower suspension resilient elements and the lens carrier. As shown in FIG. 3, the movable parts 141b, 142b (not shown) of the upper and lower suspension resilient elements 141, 142 are connected to the upper part and lower part of the lens carrier 110 respectively. The fixed parts 141a, 142a are fixed to the upper cover 150 (not shown) and the base 160 respectively. Therefore, the lens carrier 110 becomes a suspension and movable object supported by the movable parts 141b, 142b of the upper and lower suspension resilient elements 141, 142. For example, the lens carrier 110 can move linearly along the axis of the lens carrier 110.

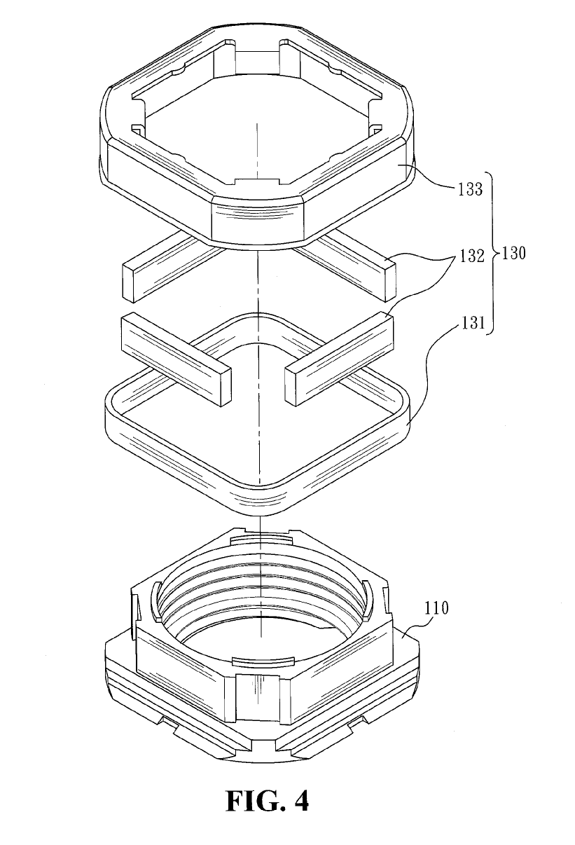

FIG. 4 shows a schematic view of the magnet module. As shown in FIG. 4, the magnet module 130 further includes a coil set 131, a magnet set 132, and an outer yoke 133, disposed in the order from the lens carrier 110 outwards. When a current runs through the coil set 131, the lens carrier 110 can move linearly along the axis of the lens carrier 110.

In summary, in the anti-shake lens driving apparatus of the present invention, the suspension part is made of resilient and anti-fatigue material with an optical mask etching process to further enhance the anti-shake functionality. With the outer yoke as the base and for positioning of the magnets as well as adding inner yoke in a specific magnetic range to further enhance the magnetic flux in specific area, the sensitivity of the lens movement is accordingly enhanced.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An anti-shake lens driving apparatus, comprising:
a lens carrier, for carrying at least a lens set;
a magnet module, disposed on the outer surroundings of said lens carrier for pushing said lens carrier;
a suspension part, further including an upper suspension resilient element and a lower suspension resilient element, said upper and said lower suspension resilient elements respectively including a fixed part, a movable part and at least a suspension element;
said at least a suspension element connecting said fixed part and said movable part;
said fixed part being fixed to an upper cover and a base; said movable part being fixed to a upper and lower part of said lens carrier respectively; and
said upper cover and said base being disposed respectively at the upper and lower part of said magnet module and said suspension part for providing protection.

2. The anti-shake lens driving apparatus as claimed in claim 1, wherein said at least a suspension element extends from said fixed part at an angle to said movable part.

3. The anti-shake lens driving apparatus as claimed in claim 1, wherein said at least a suspension element is a U-shape buffer element.

4. The anti-shake lens driving apparatus as claimed in claim 1, wherein said upper suspension resilient element and said lower suspension resilient element are formed monolithically.

5. The anti-shake lens driving apparatus as claimed in claim 1, wherein said magnet module further comprises a coil set, a magnet set and an outer yoke, disposed in the order from said lens carrier 1 outwards; and when a current runs through the coil set, said lens carrier moves linearly along the axis of said lens carrier.

6. The anti-shake lens driving apparatus as claimed in claim 1, wherein said outer yoke is formed monolithically.

7. The anti-shake lens driving apparatus as claimed in claim 1, wherein each of the four corners of said outer yoke is disposed with an inner yoke.

8. The anti-shake lens driving apparatus as claimed in claim 2, wherein rigidity of the upper and lower suspension resilient elements can be adjusted by the cord width of said at least a suspension element to achieve the compensation of the tile angle.
